(19) United States
(12) Patent Application Publication
(10) Pub. No.: US 2026/0204926 A1
(43) Pub. Date: Jul. 16, 2026

(54) Power Adjustment Device and Charging System

(71) Applicant: DARFON ELECTRONICS CORP., Taoyuan City (TW)

(72) Inventor: Chia-Chun Chou, Taoyuan City (TW)

(73) Assignee: DARFON ELECTRONICS CORP., Taoyuan City (TW)

(21) Appl. No.: 19/446,943

(22) Filed: Jan. 13, 2026

Related U.S. Application Data
(60) Provisional application No. 63/744,819, filed on Jan. 13, 2025.

(30) Foreign Application Priority Data
Dec. 31, 2025 (TW) 114152249

(51) Int. Cl. H02J 7/34; H02J 7/00; H02J 7/40; H02J 7/90; B60L 53/60

(52) U.S. Cl. CPC H02J 7/34; H02J 7/40; H02J 7/865; H02J 7/933; B60L 53/60; B60L 2210/10; H02J 2207/20

(57) ABSTRACT

A charging system includes a first device, a second device, and a power conditioning device. The power conditioning device includes a switch, a DC-DC conversion unit, a power transfer controller, and a DC controller. The power transfer controller performs the following operations: receiving a charging instruction and first power information from the first device; determining whether the second device is in a discharging state or a charging state according to the charging instruction and controlling the switch to conduct; and instructing the first device to output or receive a first charging current according to the first power information. The DC controller controls the DC-DC conversion unit to convert the first charging current into a second charging current to charge the second device, or controls the DC-DC conversion unit to convert the second supply current into the first charging current to charge the first device.

### CROSS REFERENCE TO RELATED APPLICATIONS

This application claims the benefit of U.S. Provisional Application No. 63/744,819, filed on January 13th, 2025. The content of the application is incorporated herein by reference.

### BACKGROUND OF THE INVENTION

### FIELD OF THE INVENTION

The present invention relates to a power adjustment device and a charging system, and more particularly, to a power adjustment device and a charging system capable of bidirectional charging and discharging.

### DESCRIPTION OF THE PRIOR ART

With the widespread adoption of electric vehicles, the application of light electric vehicles has also gained attention, including electric assist bicycles, electric motorcycles, electric wheelchairs, and golf carts. Currently, the development of light electric vehicles is limited by battery capacity, which restricts their ranges. Therefore, more batteries need to be connected in parallel to increase capacity. For example, a light electric vehicle can be equipped with a master battery and one or more auxiliary batteries to extend its range. However, current light electric vehicles can only charge the master and auxiliary batteries through an AC charger and cannot directly charge the master and auxiliary batteries through an external battery or other external power sources. Additionally, the master and auxiliary batteries of light electric vehicles cannot directly provide power to external batteries or other external devices.

Therefore, managing the power of external devices, master batteries, and auxiliary batteries, as well as controlling the bidirectional charging and discharging of external devices, master batteries, and auxiliary batteries, has become one of the industry's goals.

### SUMMARY OF THE INVENTION

Therefore, the purpose of the present invention is to provide a power adjustment device and a charging system to solve the above problems.

The present invention provides a charging system, comprising: a first device, coupled to a first node; a second device, coupled to a second node; and a power adjustment device, wherein the power adjustment device comprises: a switch, coupled to the first node and a third node; a DC-to-DC conversion unit, coupled to the second node and the third node; a power transfer controller, coupled to the first device and the switch; and a DC controller, coupled to the power transfer controller and the DC-to-DC conversion unit; wherein the power transfer controller is configured to execute the following steps: establishing a power transfer protocol with the first device; receiving a charging command and a first power information of the first device after establishing the power transfer protocol, wherein the first power information comprises a first output voltage range, a first output power range, a first input voltage range, and a first input power range; defining the second device to be in a discharge state or a charge state according to the charging command, and controlling the switch to conduct; when the second device is in the charge state, instructing the first device to output a first charging current at a first output voltage within the first output voltage range and a first output power within the first output power range according to the first power information; and when the second device is in the discharge state, instructing the first device to receive a first charging current at a first input voltage within the first input voltage range and a first input power within the first input power range according to the first power information; wherein the DC controller is configured to execute the following steps: when the second device is in the charge state, controlling the DC-to-DC conversion unit to convert the first charging current output by the first device into a second charging current to charge the second device; and when the second device is in the discharge state, controlling the DC-to-DC conversion unit to convert a second supply current output by the second device into the first charging current to charge the first device.

The present invention provides a power adjustment device, for a first device and a second device, wherein the power adjustment device comprises: a switch, coupled to a first node and a third node, wherein the first device is coupled to the first node; a DC-to-DC conversion unit, coupled to a second node and the third node, wherein the second device is coupled to the second node; a power transfer controller, coupled to the first device and the switch; and a DC controller, coupled to the power transfer controller and the DC-to-DC conversion unit; wherein the power transfer controller is configured to execute the following steps: establishing a power transfer protocol with the first device; receiving a charging command and a first power information of the first device after establishing the power transfer protocol, wherein the first power information comprises a first output voltage range, a first output power range, a first input voltage range, and a first input power range; defining the second device to be in a discharge state or a charge state according to the charging command, and controlling the switch to conduct; when the second device is in the charge state, instructing the first device to output a first charging current at a first output voltage within the first output voltage range and a first output power within the first output power range according to the first power information; and when the second device is in the discharge state, instructing the first device to receive a first charging current at a first input voltage within the first input voltage range and a first input power within the first input power range according to the first power information; wherein the DC controller is configured to execute the following steps: when the second device is in the charge state, controlling the DC-to-DC conversion unit to convert the first charging current output by the first device into a second charging current to charge the second device; and when the second device is in the discharge state, controlling the DC-to-DC conversion unit to convert a second supply current output by the second device into the first charging current to charge the first device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a charging system according to an embodiment of the present invention.

FIG. 2 is a schematic diagram of another charging system according to an embodiment of the present invention.

FIG. 3 is a schematic diagram of another charging system according to an embodiment of the present invention.

FIG. 4 is a schematic diagram of another charging system according to an embodiment of the present invention.

FIG. 5 is a schematic diagram of another charging system according to an embodiment of the present invention.

FIG. 6 is a schematic diagram of another charging system according to an embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”. Also, the term “couple” is intended to mean either an indirect or direct electrical connection. Accordingly, if one device is coupled to another device, that connection may be through a direct electrical connection, or through an indirect electrical connection via other devices and connections.

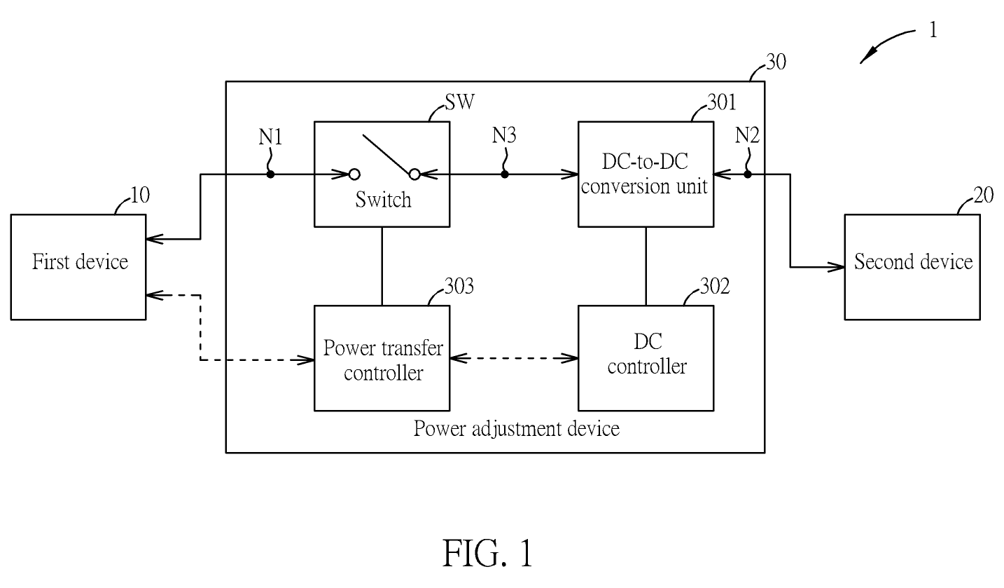

Please refer to FIG. 1, which is a schematic diagram of a charging system 1 according to an embodiment of the present invention. The charging system 1 includes a first device 10, a second device 20, and a power adjustment device 30. The power adjustment device 30 is coupled to the first device 10 and the second device 20, and is configured to control the first device 10 to discharge to charge the second device 20 or to control the second device 20 to discharge to charge the first device 10. Specifically, the power adjustment device 30 includes a DC-to-DC conversion unit 301, a DC controller 302, a power transfer controller 303, and a switch SW. The first device and the switch SW are coupled to a first node N1, the DC-to-DC conversion unit 301 and the second device 20 are coupled to a second node N2, and the switch SW and the first device 10 are coupled to a third node N3. The power transfer controller 303 is coupled to the first device 10 and the switch SW, and is configured to establish a power transfer protocol with the first device 10, and after establishing the power transfer protocol, to receive a charging command and first power information of the first device 10. The power transfer controller 303 can define the second device 20 to be in a discharge state or a charge state according to the charging command, and control the switch SW to conduct. The DC controller 302 is coupled to the power transfer controller 303 and the DC-to-DC conversion unit 301, and is configured to control the DC-to-DC conversion unit 301 to charge or discharge the first device 10 and the second device 20 according to the discharge state and the charge state defined by the power transfer controller 303, i.e., bidirectional charging and discharging. In other words, the charging command instructs the first device 10 to discharge to charge the second device 20 or instructs the second device 20 to discharge to charge the first device 10. It should be noted that the charging command can be input by a user through a user interface (not shown in FIG. 1), or generated by a controller of the first device 10, the second device 20, or the power adjustment device 30 (not shown in FIG. 1), and is not limited thereto. In addition, the solid arrows in FIG. 1 represent the paths of charging or discharging, and the dashed arrows represent the transmission paths of the first power information and the charging command.

Please note that the power transfer controller 303 can communicate with the first device 10 through a communication interface to receive the first power information. The first power information may include a first output voltage range, a first output power range, a first input voltage range, and a first input power range, but is not limited to these. In an embodiment, when the second device is in a charging state, the power transfer controller 303 can instruct the first device 10 to output a first charging current at a first output voltage within the first output voltage range and a first output power within the first output power range according to the first power information. The DC controller 302 can control the DC-to-DC conversion unit 301 to convert the first charging current output by the first device 10 into a second charging current to charge the second device 20. In another embodiment, when the second device 20 is in a discharging state, the power transfer controller 303 can instruct the first device 10 to receive a first charging current at a first input voltage within the first input voltage range and a first input power within the first input power range according to the first power information. The DC controller 302 can control the DC-to-DC conversion unit 301 to convert a second supply current output by the second device 20 into the first charging current to charge the first device 10. It should be noted that the communication interface can be an inter-integrated circuit (I2C), a universal asynchronous receiver/transmitter (UART), or a controller area network (CAN), but is not limited to these. Additionally, the inter-integrated circuit, universal asynchronous receiver/transmitter, and controller area network are well-known vehicle communication protocols in the field and will not be elaborated here.

It should be noted that FIG. 1 is only an embodiment of the present invention, and those skilled in the art can make appropriate adjustments according to system requirements. For example, the charging system of the present invention can be applied to an electric assist bicycle, but is not limited to this. As long as it is applied to a system requiring bidirectional charging and discharging functions, it should fall within the scope of the present invention. For convenience of explanation, in the following embodiments, the charging system is applied to the electric assist bicycles.

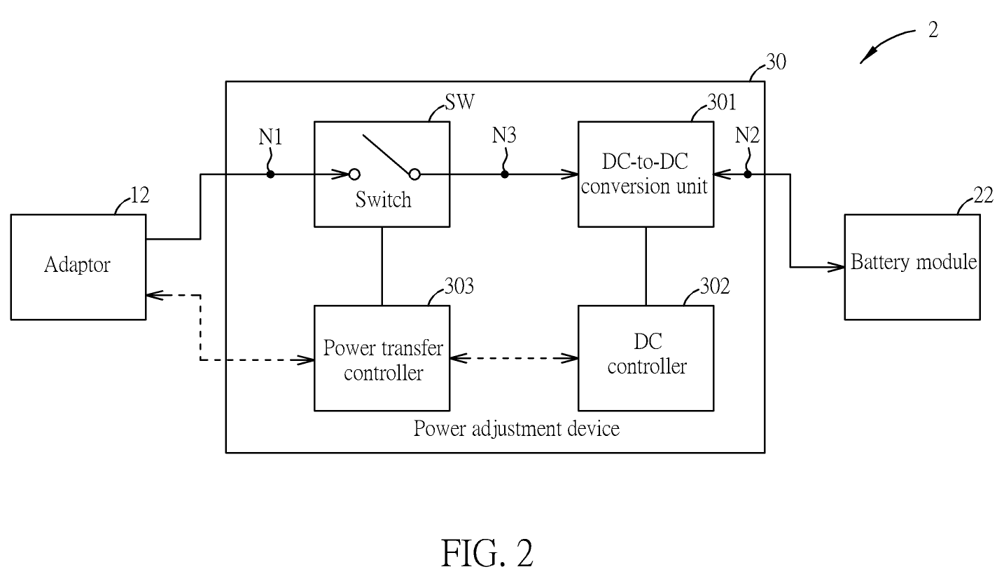

In an embodiment, please refer to FIG. 2, which is a schematic diagram of a charging system 2 according to an embodiment of the present invention. In the charging system 2, the first device 10 can be an adapter 12, such as a charger or a portable power source that complies with the Universal Serial Bus (USB) Power Delivery (PD) standard or the Quick Charge (QC) standard. The second device 20 can be a battery module 22, such as the main battery module of an electric assist bicycle. In an embodiment, if the adapter 12 is a dedicated charger for the electric assist bicycle, the power transfer controller 303 is configured to establish a power transfer protocol with the adapter 12 and, after establishing the power transfer protocol, to communicate with the adapter 12 through a communication interface to receive the first power information of the adapter 12. The first power information may include the first output voltage range, the first output power range, the first input voltage range, and the first input power range of the adapter 12, but is not limited to these. The power transfer controller 303 can define the battery module 22 to be in a discharge state or a charge state according to the charging command and control the switch SW to conduct. The DC controller 302 is coupled to the power transfer controller 303 and the DC-to-DC conversion unit 301, and is configured to control the DC-to-DC conversion unit 301 to charge the battery module 22 according to the charge state defined by the power transfer controller 303. In another embodiment, if the adapter 12 is a portable power source that complies with the USB Power Delivery standard or the Quick Charge standard, the power transfer controller 303 can define the battery module 22 to be in a discharge state or a charge state according to the charging command and control the switch SW to conduct. The DC controller 302 is coupled to the power transfer controller 303 and the DC-to-DC conversion unit 301, and is configured to control the DC-to-DC conversion unit 301 to discharge or charge the battery module 22 according to the discharge state and charge state defined by the power transfer controller 303.

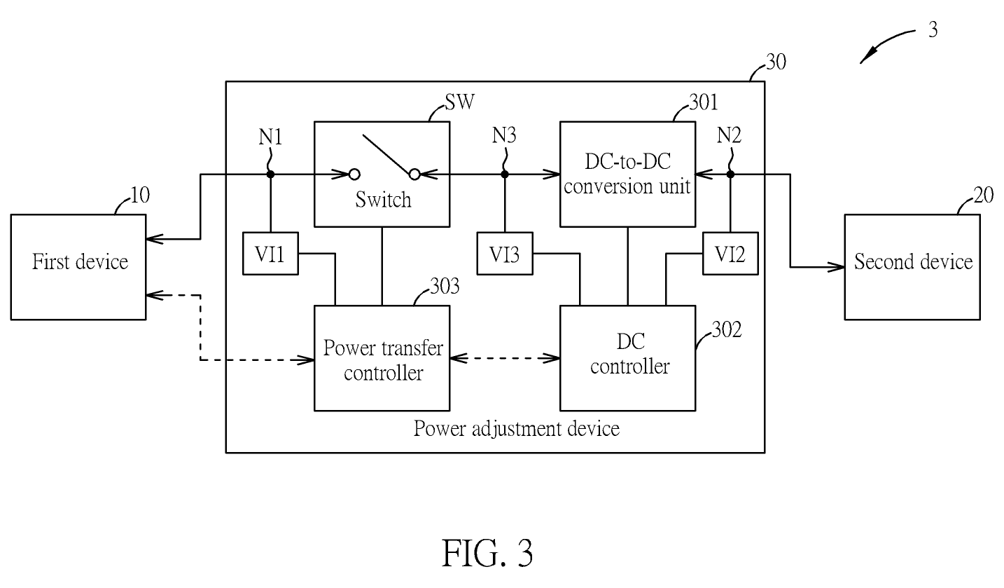

Please note that the power transfer controller 303 can include one or more detection units to monitor the voltage at various nodes along the charging and discharging paths, protecting the components of the charging system from damage due to excessive voltage. Please refer to FIG. 3, which is a schematic diagram of a charging system 3 according to an embodiment of the present invention. In an embodiment, the power transfer controller 303 includes a first detection unit VI1 to monitor the voltage at the first node N1. Specifically, when the first voltage is lower than the first output voltage or the first input voltage, the power transfer controller 303 will not turn on the switch SW. Conversely, the power transfer controller 303 can define the battery module 22 to be in a discharge state or a charge state according to the charging command and turn on the switch SW when the first voltage equals the first output voltage or the first input voltage. Once the switch SW is turned on, the DC controller 302 can control the DC-to-DC conversion unit 301 to charge or discharge the first device 10 and the second device 20 according to the discharge state and charge state defined by the power transfer controller 303, i.e., bidirectional charging and discharging. In another embodiment, the power transfer controller 303 includes a second detection unit VI2 and a third detection unit VI3 to monitor the voltage at the second node N2 and the third node N3, respectively. In this way, once the switch SW is turned on, the DC controller 302 can determine the first charging current of the first device and the second charging current of the second device according to the second voltage and the third voltage, and instruct the DC-to-DC conversion unit 301 to allow the first device 10 and the second device 20 to charge and discharge each other with the first charging current and the second charging current. In short, the power transfer controller 303 can prevent unsuitable charging specifications from damaging the first device 10 and the second device 20.

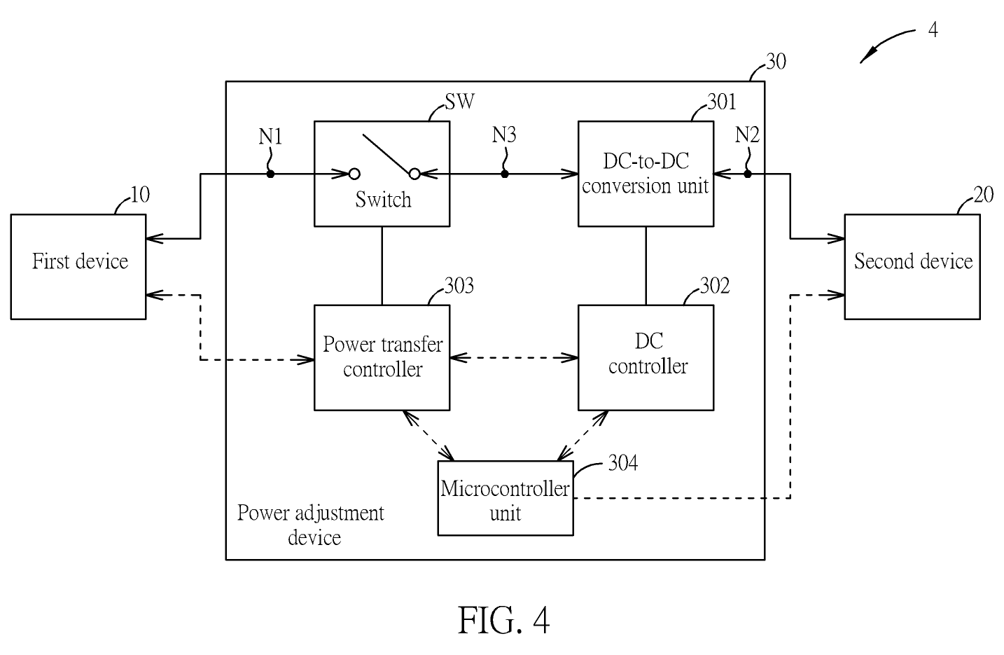

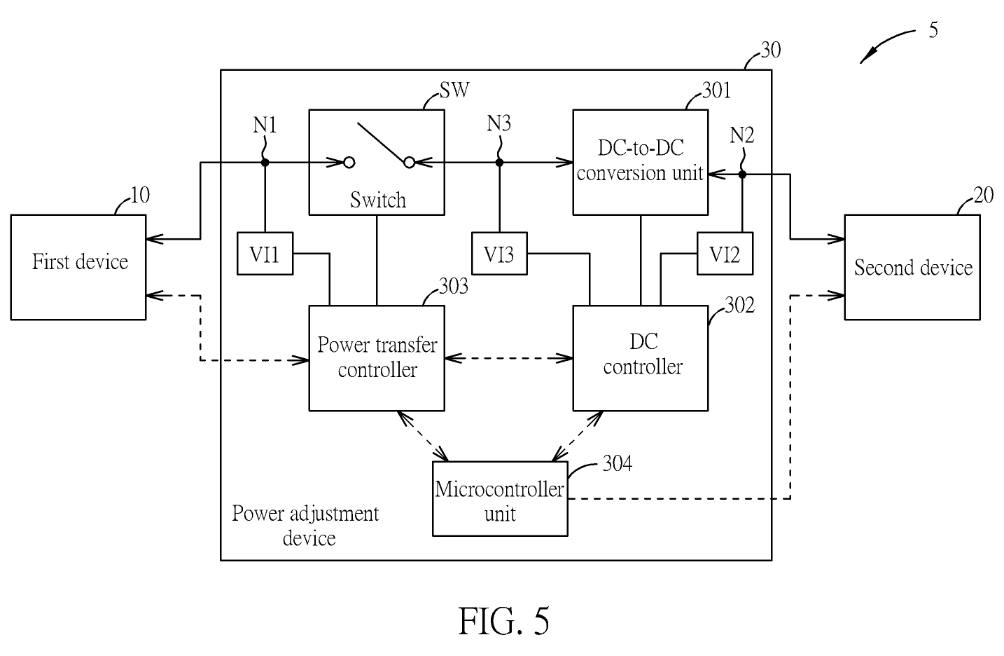

Please note that the power adjustment device 30 in the aforementioned charging systems 1 to 3 can be applied in scenarios where the second device 20 and the battery module 22 do not provide the power information, or where the power adjustment device 30 does not receive the power information from the second device 20. Furthermore, for scenarios where the second device 20 and the battery module 22 provide power information, or where the power adjustment device 30 receives power information from the second device 20, please refer to FIG. 4 and FIG. 5. FIG. 4 and FIG. 5 are schematic diagrams of a charging system 4 and a charging system 5 according to embodiments of the present invention. The power adjustment device 30 of the charging systems 4 and 5 can further include a microcontroller unit 304. It should be noted that the charging systems 4 and 5 are derived from the charging systems 1 and 3, so the same components are represented by the same symbols.In the charging system 4, the microcontroller unit 304 is coupled to the power transfer controller 303, the DC controller 302, and the second device 20. It is configured to receive the first power information from the power transfer controller 303 and the second power information from the second device 20. The second power information includes a second output voltage range, a second output power range, a second input voltage range, and a second input power range. In this way, the microcontroller unit 304 can determine a second output voltage within the second output voltage range, a second output power within the second output power range, a second input voltage within the second input voltage range, and a second input power within the second input power range. The microcontroller unit 304 then instructs the DC controller 302 to control the DC-to-DC conversion unit 301 to allow the first device 10 and the second device 20 to charge and discharge each other. For example, the microcontroller unit 304 instructs the second device 20 to output a second charging current with the second output voltage and the second output power, and the second device 20 to receive the second charging current with the second input voltage and the second input current.

In the charging system 5, the microcontroller unit 304 can receive the first power information from the power transfer controller 303 and the second power information from the second device 20. According to the second voltage at the second node N2, the third voltage at the third node N3, and the second power information, The microcontroller unit 304 determines the second output voltage within the second output voltage range, the second output power within the second output power range, the second input voltage within the second input voltage range, and the second input power within the second input power range. The microcontroller unit 304 then instructs the DC controller 302 to control the DC-to-DC conversion unit 301 to allow the first device 10 and the second device 20 to charge and discharge each other. For detailed descriptions and variations of the charging systems 4 and 5, please refer to the previous descriptions.

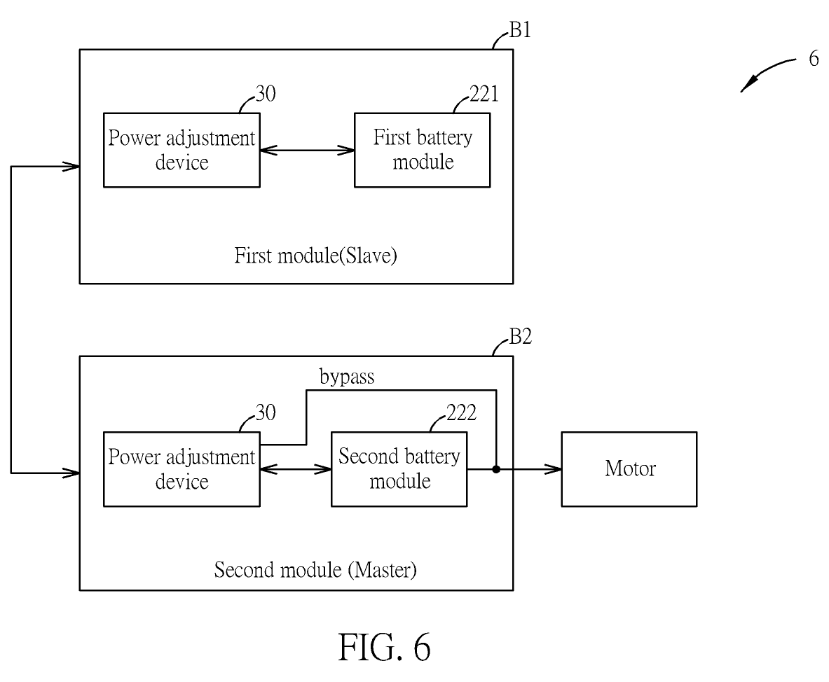

It should be noted that the charging systems 1 to 5 are different embodiments of the present invention, and those skilled in the art can make various modifications according to the system requirements without being limited to these embodiments. For example, the power adjustment device 30 and the main battery of the electric assist bicycle can be encapsulated in a packaging module or attached to the outside of the battery body. Please refer to FIG. 6, which is a schematic diagram of a charging system 6 according to an embodiment of the present invention. In the charging system 6, the first module B1 and the second module B2 can be the main (Master) battery and the auxiliary (Slave) battery of an electric assist bicycle, or the main batteries of two electric assist bicycles, respectively. Specifically, the first module B1 and the second module B2 can be connected through a universal serial bus cable, and the user can input a charging command through a user interface (not shown in FIG. 1) to instruct the first module B1 to charge the second module B2 or the second module B2 to charge the first module B1. Furthermore, as shown in FIG. 6, the second module B2 is coupled to the motor of the electric assist bicycle. The power adjustment device 30 of the second module B2 can communicate with the power adjustment device 30 of the first module B1 to indicate the discharge mode of the first module B1 and the second module B2. In an embodiment, the power adjustment device 30 of the second module B2 instructs the first battery module 221 and/or the second battery module 222 to discharge to the motor. For example, the first battery module 221 discharges to the motor through a bypass path bypass. For detailed descriptions and variations of the charging system 6, please refer to the previous descriptions.

It should be noted that the charging systems 1 to 6 are the embodiments of the present invention. Those skilled in the art should readily make combinations, modifications and/or alterations on the abovementioned description and examples. The abovementioned description, steps, procedures and/or processes including suggested steps can be realized by means that could be hardware, software, firmware (known as a combination of a hardware device and computer instructions and data that reside as read-only software on the hardware device), an electronic system, or combination thereof. Examples of hardware can include analog, digital and mixed circuits known as microcircuit, microchip, or silicon chip. Examples of the electronic system may include a system on chip (SoC), system in package (SiP), a computer on module (CoM) and the computer system. Any of the abovementioned procedures and examples above may be compiled into program codes or instructions that are stored in a storage unit. The storage unit may include read-only memory (ROM), flash memory, random access memory (RAM), subscriber identity module (SIM), hard disk, or CD-ROM/DVD-ROM/BD-ROM, but not limited thereto. The DC controller 302, the he power transfer controller 303 and the microcontroller unit 304 may read and execute the program codes or the instructions stored in the storage unit for realizing the abovementioned functions.

In summary, in the charging system of the present invention, the power adjustment device detects or receives the charging specifications of the first device and the second device, and controls the first device and the second device to perform bidirectional charging and discharging according to the appropriate charging specifications to avoid damage to each other. As a result, compared to the prior art, the charging system of the present invention can support the charging devices and the battery modules of a wider range of the specifications.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A charging system, comprising:
a first device, coupled to a first node;
a second device, coupled to a second node; and
a power adjustment device, comprising:
a switch, coupled to the first node and a third node;
a DC-to-DC conversion unit, coupled to the second node and the third node;
a power transfer controller, coupled to the first device and the switch; and
a DC controller, coupled to the power transfer controller and the DC-to-DC conversion unit;
wherein the power transfer controller is configured to execute the following steps:
establishing a power transfer protocol with the first device;
receiving a charging command and a first power information of the first device after establishing the power transfer protocol, wherein the first power information comprises a first output voltage range, a first output power range, a first input voltage range, and a first input power range;
defining the second device to be in a discharge state or a charge state according to the charging command, and controlling the switch to conduct;
when the second device is in the charge state, instructing the first device to output a first charging current at a first output voltage within the first output voltage range and a first output power within the first output power range according to the first power information; and
when the second device is in the discharge state, instructing the first device to receive a first charging current at a first input voltage within the first input voltage range and a first input power within the first input power range according to the first power information;
wherein the DC controller is configured to execute the following steps: when the second device is in the charge state, controlling the DC-to-DC conversion unit to convert the first charging current output by the first device into a second charging current to charge the second device; and when the second device is in the discharge state, controlling the DC-to-DC conversion unit to convert a second supply current output by the second device into the first charging current to charge the first device.

2. The charging system of claim 1, wherein the power adjustment device further comprises:
a first detection unit, configured to detect a first voltage of the first node;
wherein the step of controlling the switch to conduct comprises:
conducting the switch when the first voltage equals the first output voltage or the first input voltage; and
turning off the switch when the first voltage is less than the first output voltage or the first input voltage.

3. The charging system of claim 2, wherein the power adjustment device further comprises:
a second detection unit, configured to detect a second voltage of the second node; and
a third detection unit, configured to detect a third voltage of the third node;
wherein the DC controller determines the first charging current and the second charging current according to the second voltage and the third voltage.

4. The charging system of claim 1, wherein the power adjustment device further comprises:
a microcontroller unit, coupled to the power transfer controller, the DC controller, and the second device, configured to receive the first power information from the power transfer controller and the second power information from the second device, wherein the second power information comprises a second output voltage range, a second output power range, a second input voltage range, and a second input power range, and configured to execute the following steps:
determining a second output voltage within the second output voltage range, a second output power within the second output power range, a second input voltage within the second input voltage range, and a second input power within the second input power range; and
instructing the second device to output the second charging current with the second output voltage and the second output power, or to receive the second charging current with the second input voltage and the second input current.

5. The charging system of claim 4, wherein the power adjustment device further comprises:
a first detection unit, configured to detect a first voltage of the first node;
wherein the step of controlling the switch to conduct comprises:
conducting the switch when the first voltage equals the first output voltage or the first input voltage; and
turning off the switch when the first voltage is less than the first output voltage or the first input voltage.

6. The charging system of claim 5, wherein the power adjustment device further comprises:
a second detection unit, configured to detect a second voltage of the second node; and
a third detection unit, configured to detect a third voltage of the third node;
wherein the DC controller determines the first charging current and the second charging current according to the second voltage and the third voltage.

7. The charging system of claim 1, wherein the first device is an adapter or a first module, and the second device is a second module.

8. The charging system of claim 7, wherein the adapter complies with the Universal Serial Bus (USB) Power Delivery (PD) standard or the Quick Charge (QC) standard.

9. A power adjustment device, for a first device and a second device, wherein the power adjustment device comprises:
a switch, coupled to a first node and a third node, wherein the first device is coupled to the first node;
a DC-to-DC conversion unit, coupled to a second node and the third node, wherein the second device is coupled to the second node;
a power transfer controller, coupled to the first device and the switch; and
a DC controller, coupled to the power transfer controller and the DC-to-DC conversion unit;
wherein the power transfer controller is configured to execute the following steps:
establishing a power transfer protocol with the first device;
receiving a charging command and a first power information of the first device after establishing the power transfer protocol, wherein the first power information comprises a first output voltage range, a first output power range, a first input voltage range, and a first input power range;
defining the second device to be in a discharge state or a charge state according to the charging command, and controlling the switch to conduct;
when the second device is in the charge state, instructing the first device to output a first charging current at a first output voltage within the first output voltage range and a first output power within the first output power range according to the first power information; and
when the second device is in the discharge state, instructing the first device to receive a first charging current at a first input voltage within the first input voltage range and a first input power within the first input power range according to the first power information;
wherein the DC controller is configured to execute the following steps: when the second device is in the charge state, controlling the DC-to-DC conversion unit to convert the first charging current output by the first device into a second charging current to charge the second device; and when the second device is in the discharge state, controlling the DC-to-DC conversion unit to convert a second supply current output by the second device into the first charging current to charge the first device.
